(19) United States
(12) Patent Application Publication
(10) Pub. No.: US 2013/0304532 A1
(43) Pub. Date: Nov. 14, 2013

(54) SYSTEM AND METHOD FOR MAINTENANCE AND MONITORING OF FILTRATION SYSTEMS

(71) Applicants: Michael N. Cormier, Burlington, CT (US); Thomas J. Hamlin, Vernon, CT (US)

(72) Inventors: Michael N. Cormier, Burlington, CT (US); Thomas J. Hamlin, Vernon, CT (US)

(21) Appl. No.: 13/881,427

(22) PCT Filed: Jan. 20, 2012
(86) PCT No.: PCT/US12/21965

§ 371 Date: May 22, 2013

Related U.S. Application Data
(60) Provisional application No. 61/436,325, filed on Jan. 26, 2011.

(51) Int. Cl. G06Q 10/06

(52) U.S. Cl. CPC G06Q 10/063114
USPC 705/7.15

(57) ABSTRACT

A method is disclosed comprising retrieving information from a remote computer node including a database circuit. The database may store usage, status, and location information from a plurality of fluid monitoring apparatus for respective fluid treatment systems located at a respective customer site. It may be determined, from the information, whether at least one of the fluid treatment systems is in need of service. The method may include determining automatically whether one or more additional fluid treatment systems, located in a predefined area surrounding another fluid treatment system, is in need of service. The method may include generating, for display, a service plan for a service agent including a service route and location of one or more fluid treatment systems to be serviced, and indicating type of service or estimated duration of service to be performed on each fluid treatment system.

### BACKGROUND

The present disclosure is directed to fluid treatment systems and more particularly, to a system for monitoring the performance of serviceable devices.

Many fluid treatment systems include serviceable fluid treatment parts such as filter cartridges, additive dispensers, and the like. These fluid treatment parts have been utilized in both residential and commercial fluid treatment systems. The life of certain fluid treatment parts tends to be limited. For example, the life of a filter cartridge is limited by its contaminant holding capacity, and the life of an additive dispenser is limited by the amount of additive in the dispenser. In general, it is difficult for a user to know or determine when a fluid treatment system part should be removed, replace and discarded or when a serviceable part should be cleaned or regenerated without the help of sensors.

In many instances, the replaceable and/or serviceable parts employed in fluid treatment systems are manufactured in accordance with particular design specifications and/or performance parameters provided by the appliance manufacturer. In many cases the portions of the filter parts are made using proprietary material or proprietary processes. Therefore, appliance manufacturers or distributors often recommend specific replacement filters parts, and that the parts be purchased from the original equipment providers to ensure the integrity and proper operation of the fluid treatment system.

Often, the owner of a fluid treatment system is not aware of the replacement filter specifications and operating parameters of the filtering systems. This can result in the owner unknowingly jeopardizing the integrity of the filtration system by replacing a used filter with an inferior or incompatible replacement filter supplied by an after-market manufacturer. Such incompatible filters can lead to malfunction of the filter, resulting in the fluid treatment system providing the user with unfiltered and potentially unsafe fluids.

### SUMMARY

The present disclosure relates generally to servicing fluid treatment systems, and more specifically, to determining the need for service and a corresponding service plan. The present disclosure is exemplified in a number of implementations and applications, some of which are summarized below.

Aspects of the present disclosure are directed to systems and methods involving use or generation of efficient service and/or service plans to a plurality of fluid treatment systems. In one embodiment, such as a system includes a respective fluid monitoring apparatus for each fluid treatment system installed at a customer site. Each of the fluid monitoring apparatuses is connected to a remote (or central) computer node including database. The computer node can include, for example, a CPU circuit, or other processor as well as the database. The database can be circuitry used to store information in electronic form. The central database collects and stores information from the fluid monitoring apparatuses regarding the status of the associated fluid treatment systems. A service provider accesses the stored information for fluid treatment systems in the service provider's area of service. The information is used to determine which fluid treatment systems are in need of service. A fluid treatment system may be in need of service because a filter has reached, or is reaching, the holding capacity of the filter. A fluid treatment system may also be in need of service because an additive dispenser is empty or almost empty. A service plan is created based on the location of the fluid treatment systems, the services needed, and the time of service. In certain embodiments, the service plan is provided to a mobile device. In various embodiments, the service plan includes a service route that has been optimized for shortest overall travel time.

Certain other embodiments of the present disclosure are directed to methods of determining service plans for servicing fluid treatment systems. One such method is based partly on retrieving service-related information from a remote or central database. The database stores usage, status, and location information for a plurality of fluid monitoring apparatuses. Each fluid monitoring apparatus is located at a customer site. The fluid monitoring apparatuses transmit at least usage and status information to the central database. From the information received from the database, a determination is made as to whether at least one of the plurality of fluid treatment systems is in need of service. In addition, the method includes determining whether one or more additional fluid treatment systems are in need of service within a predetermined time range. The additional fluid treatment systems are located in a predefined area surrounding the at least one of the plurality of fluid treatment systems. A service plan is generated for a service agent. The service plan includes a route, the location of the fluid treatment systems to be serviced, the type of service to be performed on each fluid treatment system, and an estimated duration of each service.

Another embodiment of the present disclosure is directed to methods of determining service plans for fluid treatment systems. In such methods, information is received from a plurality of fluid monitoring apparatuses. Each of the fluid monitoring apparatuses is located at a respective customer site and monitors the activity of a fluid treatment system. A determination is made, based on the information received from the plurality of fluid monitoring apparatuses, whether one or more of the plurality of fluid treatment systems is in need of service. A second determination is made, in response to one or more of the plurality of fluid treatment systems being in need of service, which of a plurality of service providers is to provide service to each of the respective fluid treatment systems in need of service. The service providers are notified of the fluid treatment systems in need of service in the service provider's service area. The service provider sends the location of a service agent and, in response, a service plan is generated that includes a route, the location of the fluid treatment systems to be serviced, the type of service to be performed on each of the fluid treatment systems and an estimated duration of each service. The service plan is then sent to the service agent.

The above summary is not intended to describe each embodiment or every implementation of the present disclosure. The figures and detailed description that follow more particularly exemplify various embodiments.

### BRIEF DESCRIPTION OF THE DRAWINGS

The disclosure may be more completely understood in consideration of the following detailed description of various embodiments of the disclosure in connection with the accompanying drawings, in which:

FIG. 1 shows a service system, according to example embodiments of the present disclosure;

FIG. 2 shows a method for creating a service plan, consistent with example embodiments of the present disclosure;

FIG. 3 shows a method of creating a service plan, consistent with example embodiments of the present disclosure; and

FIG. 4 shows a method of creating a service plan, consistent with example embodiments of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure, including aspects defined by the claims.

### DETAILED DESCRIPTION

The present disclosure is believed to be useful for creating efficient service plans for service providers. Specific applications of the present disclosure relate to providing service for a variety of fluid treatment systems within a specified geographical area. While the present disclosure is not necessarily limited to such applications, various aspects of the disclosure may be appreciated through a discussion of various examples using this context.

In various embodiments, a fluid treatment system is installed at a customer site for a particular application. The fluid treatment system includes a fluid monitoring apparatus. The fluid monitoring apparatus monitors various aspects of the functioning of the fluid treatment system. Depending on the particular application, the fluid monitoring apparatus monitors the effectiveness of the fluid treatment system, the levels of various chemicals used in the system, and filter life for the filters in the system. To determine the effectiveness of the fluid treatment system, the fluid monitoring apparatus can monitor the chemical composition of the water coming out of the filter. The monitoring apparatus may also monitor aspects of the fluid treatment system such as flow rate and pressure drop, for example.

In certain more specific embodiments, the fluid monitoring apparatus includes a database with information regarding desired performance levels. The information from various sensors within the fluid monitoring apparatus is compared to threshold values or ranges stored within the database. A processor or other logic circuitry (e.g., discrete and/or programmable) that performs the comparison can also make determinations regarding whether changes to the fluid treatment system need to be made. In some instances, the fine-tuning may be done by the fluid treatment system, for example, by lowering the rate at which a particular chemical is added during the treatment process. In other instances, a determination can be made that service is needed. The determination that service is needed can be based on the level of additive left in an additive dispenser, for example, or the capacity for contaminants left in a filter. A determination can also be made that service will be needed soon. For example, when the level of an additive in an additive dispenser falls below a first level, a determination can be made that the fluid treatment system will be in need of service in the near future. When the level of the additive falls below a second, lower level, a determination can be made that the fluid treatment system is in need of more immediate service.

In various embodiments, the fluid treatment system, and the fluid monitoring apparatus in particular, include functionality for communicating over the Internet with a remote database. The

Internet (and/or related local or broadband network) connection can be implemented using RFID (radio frequency identification), Wi-Fi, or another Internet providing apparatus. The substantive Internet communication can be effectively one-way, with the fluid monitoring apparatus providing information to the remote database (e.g., via smartphone/CPU text or email message). In other embodiments, substantive two-way communications is possible. For example, in certain embodiments the fluid monitoring apparatus includes a display that a customer checks on a regular basis. The display indicates when service is needed and, based on the two-way communication with the remote database or another computer or mobile device over the Internet, the display can also indicate to the customer when service can be expected.

A database receives information from a plurality of fluid monitoring apparatuses located at a plurality of customer sites. In certain embodiments, the database is central insofar as being accessible at a location that is perceived as being remote to at least one resource (e.g., smartphone, RFID, CPU or other electronically-communicative node) sending data to or receiving data from the database. Thus, the central (or remote) database receives information from fluid treatment systems within a defined service area associated with a particular service provider. In other embodiments, the central database receives information from all fluid treatment systems of a particular type for customers with a service agreement, regardless of the service provider. In still other embodiments, the central database receives information from multiple types of fluid treatment systems, and across multiple service areas. The central database can be programmed to receive information only from those customer sites with a service agreement in place, or from customer sites that do not have a current service agreement.

In various embodiments, a service provider accesses the central database using a computer or other processor. The computer can access the database at regular time intervals. In accessing the database, the service provider searches the central database for information regarding customers under a service agreement with the service provider. In various embodiments, the service provider downloads the information for all of the fluid treatment systems for all customers with a service agreement to the computer or mobile device. The service provider's computer runs a program that searches and processes the information to determine which fluid treatment systems are in need of service, and what type of services are needed. The service provider can also determine if a fluid treatment system will need service within a certain period of time. The program can also prioritize the service needs based on urgency. The program can also divide the fluid treatment systems into groups based on location, type of service, or other factors specified by the service provider. In embodiments where the service provider has more than one service agent to make service calls, can be turned into a service plan for particular service agent. The service plan can include, for example, one or more of the following: a list of parts needed to complete the various service stops; ordering parts not in stock; a service route; estimated time for each service to be performed; and an estimated time of arrival at each customer site. The program can also email each customer with an estimated arrival time, and an indication of the services to be performed.

In certain (more-specific) embodiments, the service plan is based, at least in part, on the location of the customer sites. The fluid treatment systems are grouped by geographic area, in a manner that results in the most time efficient service routes. In addition, the service plan can be provided to a mobile device, such as a cell phone, so that the service agent can keep track of the plan and update the plan as services are completed. In embodiments where the mobile device includes GPS, the service plan can provide turn-by-turn directions to the service agent. The program can also update the service route based on unforeseen circumstances, such as detours.

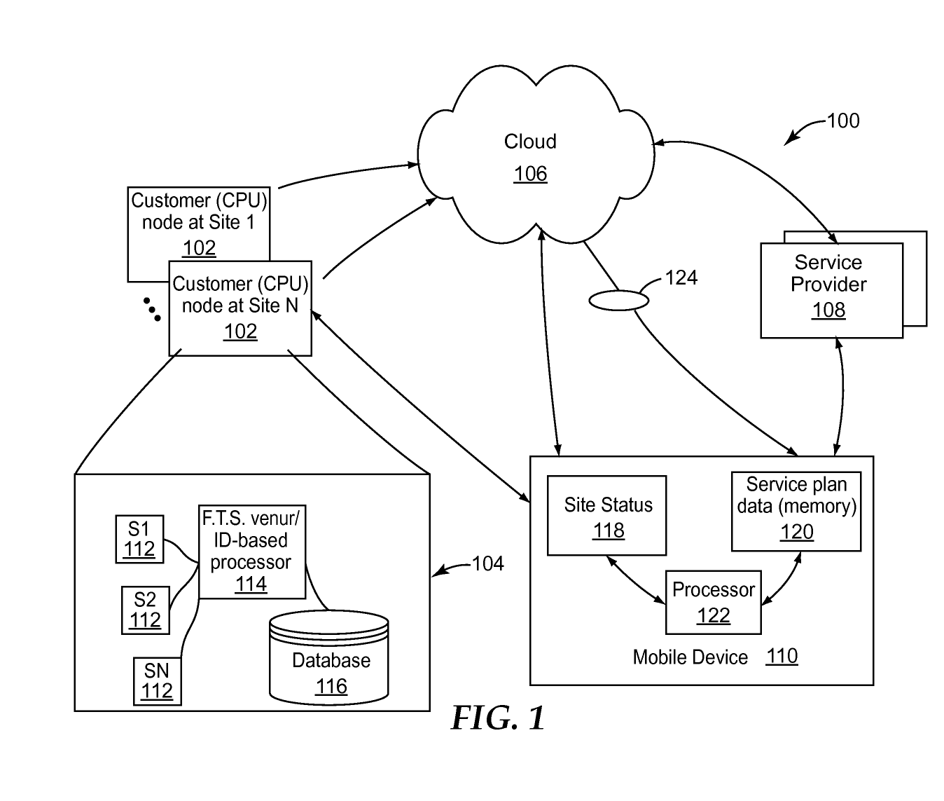

Turning now to the figures, FIG. 1 illustrates an example service system 100 consistent with various embodiments of the present disclosure. The system 100 includes multiple customer sites 102 each of which includes a fluid treatment system and a fluid monitoring apparatus 104. Fluid monitoring apparatus 104 includes a processor 114, a database 116 and a plurality of sensors 112, S1-SN Each sensor collects information regarding the functioning of the fluid treatment system. The sensors 112 monitor a variety of aspects of the fluid treatment system. For example, one of the sensors 112 can monitor fluid flow rate. Another sensor 112 monitors pressure drop set points, and still another can measure longevity (time in service) set points. The basic sensing aspects of the sensors 112 and overall system (including such sensor mechanics, communications and storage relative to the server and RFID communications) are conventional as exemplified in connection with the illustrations and related discussions provided in U.S. Pat. No. 7,638,042 to Robert E. Astle et al., entitled, “System for Monitoring the Performance of Fluid Treatment Cartridges,” and in U.S. Pat. No. 6,332,110 to Thomas D. Wolfe, entitled, “Method for Monitoring Advanced Separation and/or Ion Exchange Processes.” Each of these references is herein incorporated by reference.

In certain embodiments, the processor 114 collects and processes the data from each sensor 112 to determine whether any portion of the fluid treatment system is in need of service, or approximately how long until service may be needed. The database 116 can store information regarding performance expectation for the fluid monitoring system. The processor compares the information gathered by the sensors 112 to the levels stored in the database, for example. Based on the comparison, the processor 114 makes a determination regarding the need for service. The database can also store information regarding the last time that service was preformed, for example. The database 116 includes information regarding the location of the fluid treatment system and fluid monitoring apparatus 104 that is provided to the processor 114. The location information can be sent, for example, to mobile device 110 or to cloud 106. The processor 114 can also use information regarding the identity (e.g., a venue ID) of the fluid treatment system or the location of the fluid treatment system to determine which service provider 108 (or mobile device 110) can access information in fluid monitoring apparatus 104. The venue ID or other identifying information regarding the fluid monitoring apparatus can be used by a provider 108 (or a mobile device 110) to determine the location of the fluid monitoring apparatus. In certain embodiments, the venue ID is sent along with status and usage information to the cloud 106, the provider 108, or the mobile device 110. The venue ID can be used to retrieve information regarding a customer site 102 or fluid monitoring apparatus 104 that is stored in a database within the cloud 106, or associated with the provider 108 or mobile device 110.

The fluid monitoring apparatus 104, as configured at each customer site 102, sends information collected from the sensors 112 to a cloud 106. The cloud 106 can be a remotely accessible computer-based node including a database and a logic circuit such as a computer programmed for interfacing between the database and the elements communicatively coupled thereto as shown in FIG. 1. In certain embodiments, the data sent to the cloud 106 is data that has been processed by processor 114, for example, to convert raw data provided by the sensors to a predetermined format common to different types of sensors or more-readily interpreted by the elements (e.g., the service provider) accessing the data for further processing. In other embodiments, the information collected by fluid monitoring apparatus 104 is passed to the cloud 106 unprocessed. In certain embodiments, the processor in the cloud 106 further processes the data received in order to aggregate information regarding the fluid treatment systems at a number of customer sites 102. The processor can also determine if one or more customer sites 102 requires service, and if a particular customer site falls within in a predetermined geographical location. The processor can also determine when each of the fluid treatment systems needs routine service.

A service provider 108 accesses information stored in the cloud 106 using a computer, for example. In certain embodiments, the service provider 108 downloads information relating to customer sites within the service providers service area from the cloud 106. The information downloaded can include the sensor readings obtained by the fluid monitoring apparatus 104, data processed by either of the fluid monitoring apparatus 104, the cloud 106 or both, or a combination of sensor readings and processed data. Based on the information obtained, a computer managed or operated by the service provider generates a service plan useful for fluid-treatment systems service personnel to visit and provide service to fluid-treatment systems at multiple customer sites. In many implementations consistent with the present disclosure, generation of the service plan takes into consideration one or more of the following: the urgency of any services needed (e.g., as indicated by the information retrieved regarding the site or issues via data provided from the cloud), the location of the customer sites (e.g., as indicated by the venue-related information such as from customer-location data stored at the cloud and/or from more real-time venue-related information as provided via service personnel), the estimated time needed to perform the service (e.g., via information previously stored at the cloud or by the service provider that indicates estimates for each type of service), any parts that may be needed to complete the appropriate service (e.g., also as indicated by information previously stored for each type of service), and the location of the service provider (e.g., also as indicated by information previously stored/provided or real-time GPS data provided by a smartphone carried by service personnel). The service provider 108 can send an email, text, call or otherwise notify the customer sites that a service agent will be coming at an expected time to the customer site to provide service. In some instances, actions by the service agent are communicatively coupled to the cloud or service provider (employer) to cause the automated generation of such electronic notification per customer-defined rule sets that include preferences for such communication types and contacts at each customer site. The notification can include the estimated time of arrival, estimates of the costs of the services to be performed and specifics, such as system-use interruptions pertaining to or ensuing from the services to be performed.

In certain more specific embodiments, the service plan, including a current service route, is sent to a mobile device 110. The mobile device 110 can communicate with the customer sites 102 on the service route, the cloud 106 and the service provider computer 108. The service route can be updated throughout the day, as a service agent with the mobile device 110 completes various projects for the day. For example, if a service stop at a particular customer site 102 takes longer than anticipated, the mobile device can update the service route based on the change in time. Further, the change in schedule can be provided to customer sites 102 yet to be serviced, the mobile device 110, the service provider 108, and/or the cloud 106. In certain embodiments, any changes to the service plan are saved, and information regarding the changes is used to provide more accurate service plans in the future.

Various embodiments include a mobile device 110 that sends and receives information regarding site status 118. In addition, the mobile device 110 can include a memory 120 (implemented as a stand-alone memory circuit and/or as part of a computer-based node) that stores service plan information. The memory 120 may also store a service plan application 124 that can be downloaded from cloud 106. In other embodiments, the service plan application 124 may be transferred to the mobile device 110 from a memory plug or a disk. The service plan application 124 can update the service plan in real time based on new status information, for example. The update to the service plan occurs in the processor 122. The mobile device can retrieve information from a fluid monitoring system 104 while a service agent is on site, or alternatively, from a remote location.

In certain embodiments of the present disclosure, location information, including GPS location information, is used in generating the service plan. The GPS location information can include the location of the customer sites, as well as the location of a service agent that will be providing the service. In embodiments where the service plan is provided to, or generated by, a mobile device, the service plan can be dynamically updated based on the location of the mobile device 110 (and the service agent).

Various embodiments of the system 100 shown in FIG. 1 process the information collected from sensors 112 at one or more locations. The system 100 can include processing at the customer sites 102, in the cloud 106 and/or at the service provider 108. Certain embodiments include some portion of the overall processing needed to provide a service plan occurring at the customer site 102, the cloud 106, the service provider 108, and the mobile device 110. In other embodiments, the processing occurs almost exclusively at the service provider 108 and the mobile device 110. Various combinations of processing occurring at the customer sites 102, in the cloud 106, on the service provider's processor 122, and on a mobile device 110 are contemplated.

In certain embodiments, the processing involves certain steps that require controlled access to the data stored at the remote/central database (e.g., at the cloud 106). Such access can involve a service provider entering a user name and password at a login interface. In response, service providers can access different categories of information based, for example, on a business agreement (monthly-access fees) and/or information specific to the service providers. An example of such controlled-information access is employee-access profiles which the service providers would set in advance to control which employees can access information. This controlled access can limit, block or provide authorized employees access to information such as proprietary customer information, customer preferences, critical issues outstanding, and other data that is critical to the businesses of the service providers.

Various embodiments of the present disclosure are directed to a method that includes computer nodes, such as the cloud 106, for receiving and storing information from a plurality of fluid monitoring apparatuses 104, each fluid monitoring apparatus being located at a respective customer site 102. The fluid monitoring apparatus monitors the activity of a fluid treatment system. In implementations wherein the cloud is accessed and/or managed separately from the service provider 108 (as opposed to the alternative embodiment with nodes being functionally/communicatively integrated) the cloud 106 receives from service provider 108 information used to identify the service provider. The information can be a username and password combination, for example. The identifying information is used to retrieve stored information associated with the service provider from a database within the cloud 106. A processor within the cloud 106 determines, based on the information received from the plurality of fluid monitoring apparatuses and the information associated with the service provider, whether one or more of the plurality of fluid treatment systems in the service provider's service area is in need of service. The processor generates a list of fluid treatment systems in need of service. The cloud 106 provides the service provider access to at least a portion of the list of fluid treatment systems in need of service. The cloud 106 generates, from the list, a service plan including a service route and the location of one or more fluid treatment system to be serviced. The plan also includes an indication of what type of service needs to be performed and/or the estimated duration of each service included in the service plan. The service plan is sent to the service provider for display.

According to the instant disclosure, various approaches are useful for conveying information from the fluid treatment system, via the sensors therein as discussed above, for providing such status, maintenance and usage information to the cloud or a service provider (or service agent) over the Internet or another communication medium. The sensors can convey information visually, audibly, electronically, magnetically or via other signal-based approaches. In certain instances, the sensors are connected directly to, or communicatively integrated with, a local computer node, CPU or other processor including memory, such as a database.

In certain embodiments, the sensors must communicate information to either a local computer node, which then provides information to a cloud or service provider. The sensors may also communicate directly with the cloud or service provider. The sensors can use an RFID approach and system as discussed in the above identified U.S. Pat. No. 7,638,042, to communicate information to the local computer node. In other instances, audio and/or visual communication is used to communicate information regarding the status of the fluid treatment system. This information can be captured using a smartphone to take pictures or record video. In other instances, the information is manually conveyed, via text-message for example, by the service personnel or by another on-site person who is prompted by the node, or a node coupled to the cloud, to review and report on the status of the fluid treatment system/sensor(s). The sensors may be connected using Wi-Fi or other internet-based communication.

In certain embodiments, the sensors store information, such as the vendor ID of the fluid treatment system, that can be read using an infrared bar code scanner. The sensor may store information on a local database, that can be transferred using a USB device, for example. In other instances, the sensor can include a USB connector or another such device connector, so that a user of the local computer, the cloud (or remote computer) or a service provider can connect the sensor to a CPU in order to facilitate the transfer of information.

In embodiments where the information from the sensors is conveyed to a local computer, the local computer can provide the information to the cloud and/or service provider through a variety of processes. For example, the computer can include a downloaded software application (or Widget) that compiles the data and displays the data on a computer screen. Such “Apps” or “Widgets” are oftentimes desirable to implement using standardized JAVA™-based code. The application can include a feature wherein the data is automatically sent to the cloud and/or service provider. In certain embodiments a customer can manually choose to send the data to the cloud and/or service provider. The data can be sent over the internet via email, for example. The information can also be sent over Wi-Fi, a cellular network, or using other known wired and wireless communication techniques. In yet other applications, e.g., where the service is addressing needs of less-sophisticated equipment that does not provide convenient e-data, the personnel collects the data in a more rudimentary form and electronically updates the database subsequent to such initial data-collection efforts.

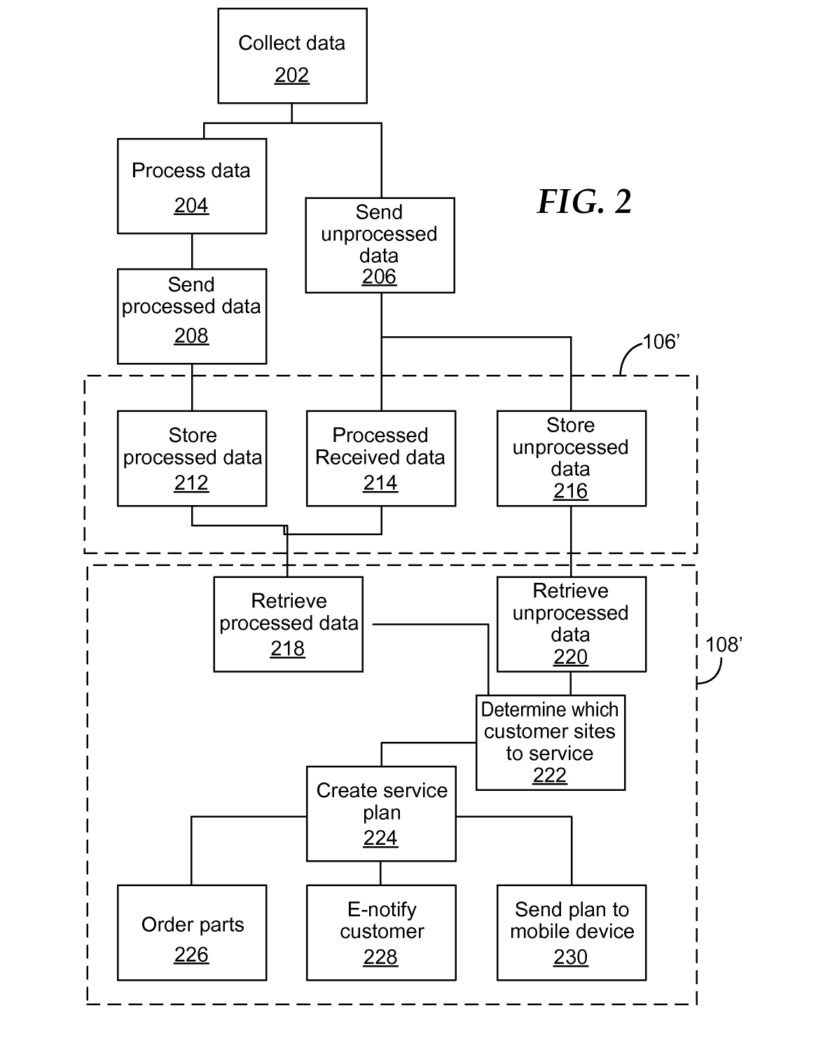

Turning to FIG. 2, a method for creating a service plan for a plurality of fluid treatment systems is shown, consistent with an embodiment of the present disclosure. Data is collected in step 202. The data is collected at a plurality of customer sites, each of which has a fluid treatment system and a fluid monitoring apparatus. The fluid monitoring apparatus includes a plurality of sensors that monitor various aspects of the fluid treatment system. The data is collected at each individual customer site from the sensors. The data is then processed in step 204, and in step 208 the processed data is sent to a central database 106′. In certain embodiments, the unprocessed data is sent as well. The central database 106′ stores the data received, both processed and unprocessed, and aggregates the data from a plurality of customer sites. The amount of processing that occurs in the fluid monitoring apparatus varies between different embodiments. The central database 106′ receives both processed and unprocessed data from a plurality of customer sites. The central database 106′ stores processed data in step 212, processes both previously processed and previously unprocessed data in step 214, and stores unprocessed data in step 216. In steps 218 and 220, processed and unprocessed data is retrieved from the central database 106′ by a service provider's computer 108′. The computer 108′ determines, in step 222, from the information retrieved in steps 218 and 220, which customer sites within the service provider's service area are in need of service. Based on the determination, a service plan is created in step 224. During the creation of the service plan, the computer 108′ may determine whether other fluid treatment systems, awaiting service in a particular area, can be serviced early, or are expected to be in need of service within a predetermined time range. The time range can be, for example, a week. The computer may also group fluid treatment systems based on similar types of services needed. For example, a service plan may include only fluid treatment systems which need a particular filter replaced. After the service plan is created, the parts necessary to complete the services included in the service plan are ordered in step 226. An email or other notification is sent to each customer whose fluid treatment system is be serviced in step 228. In addition, the plan is sent to a mobile device of a service agent who is to follow the service plan in step 230.

In certain embodiments of the present disclosure, the data collected in step 202 includes a variety of information regarding the functioning of the fluid treatment system. The information can include data regarding flow rate, pressure drop, capacity of filters and longevity of filters. A fluid monitoring apparatus located at the customer site, and connected to the fluid treatment system, can compare raw data regarding flow rate, etc. to set points stored in a database in step 204. The set points can be based on threshold tolerances of the fluid treatment system. In certain embodiments, if the data collected falls below (or crosses above) a set point, a change in status for the fluid treatment system is recorded. The status of the fluid treatment system can indicate that at least a portion of the fluid treatment system is in need of service. The threshold can be set so that service does not need to be done immediately, but rather serves as a warning that a filter will soon need to be replaced, for example. The setting of the threshold below the critical level allows for a service provider to order, and receive, parts necessary to fix the fluid treatment system before it fails. In certain embodiments, data is sent to the central database 106′ each time a status of the fluid treatment system changes. In other embodiments, the data may be sent, in steps 206 and 208, at regular time intervals or in response to a query by the central database. The data can be sent, in steps 206 and 208, over the Internet. The fluid monitoring apparatus can include RFID, Wi-FI, or another mechanism by which the apparatus can send and receive information over the Internet.

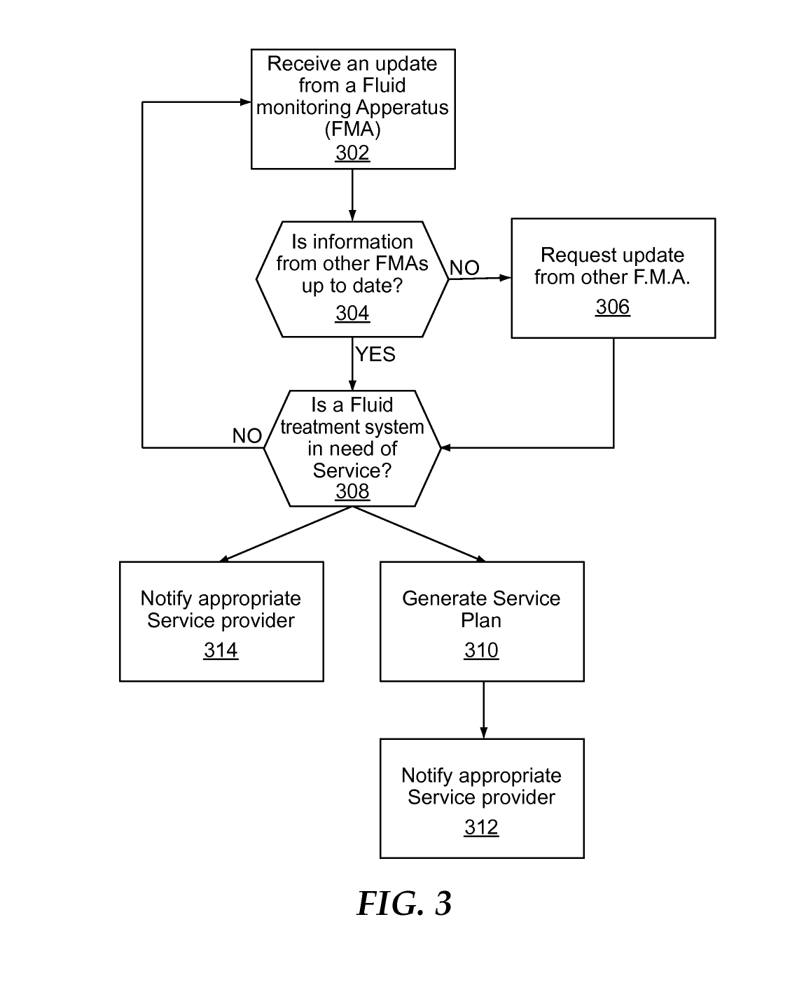

FIG. 3 shows a method of creating a service plan, consistent with embodiments of the present disclosure. Certain embodiments include the process undergone by cloud 106 from FIG. 1. In step 302, a cloud or central database receives an update from a fluid monitoring apparatus. In response to the receipt of new information from one of a plurality of fluid monitoring apparatus for which the cloud stores information, the cloud determines whether the information stored regarding other fluid monitoring apparatus is up-to-date in step 304. The determination can be made for all fluid monitoring apparatus, or for a subset of fluid monitoring apparatus. This determination can be made based on a time frame, for example. If the data for a particular fluid monitoring apparatus was received outside of a predetermined time frame, then in step 306 the cloud requests updated information from the fluid monitoring apparatus. In step 308, the cloud makes a determination based on the information retrieved whether one or more of the fluid treatment systems are in need of service. If there are fluid treatment systems in need of service, the cloud can notify a service provider in step 314. The service provider notified can be chosen based on the location of the fluid treatment system in need of service and the location of the service provider. The choice may also be made based on information stored in the cloud regarding which service provider has a service contract to service the fluid treatment system. Alternatively, in step 310 the cloud generates a service plan. The service plan can include one or more fluid treatment systems in need of service. Creation of the service plan can take into consideration the relative locations of the fluid treatment systems in need of service. In certain embodiments, multiple service plans are created (each service plan for a predetermined service area). Each plan is then provided to the appropriate service provider based on service area in step 312.

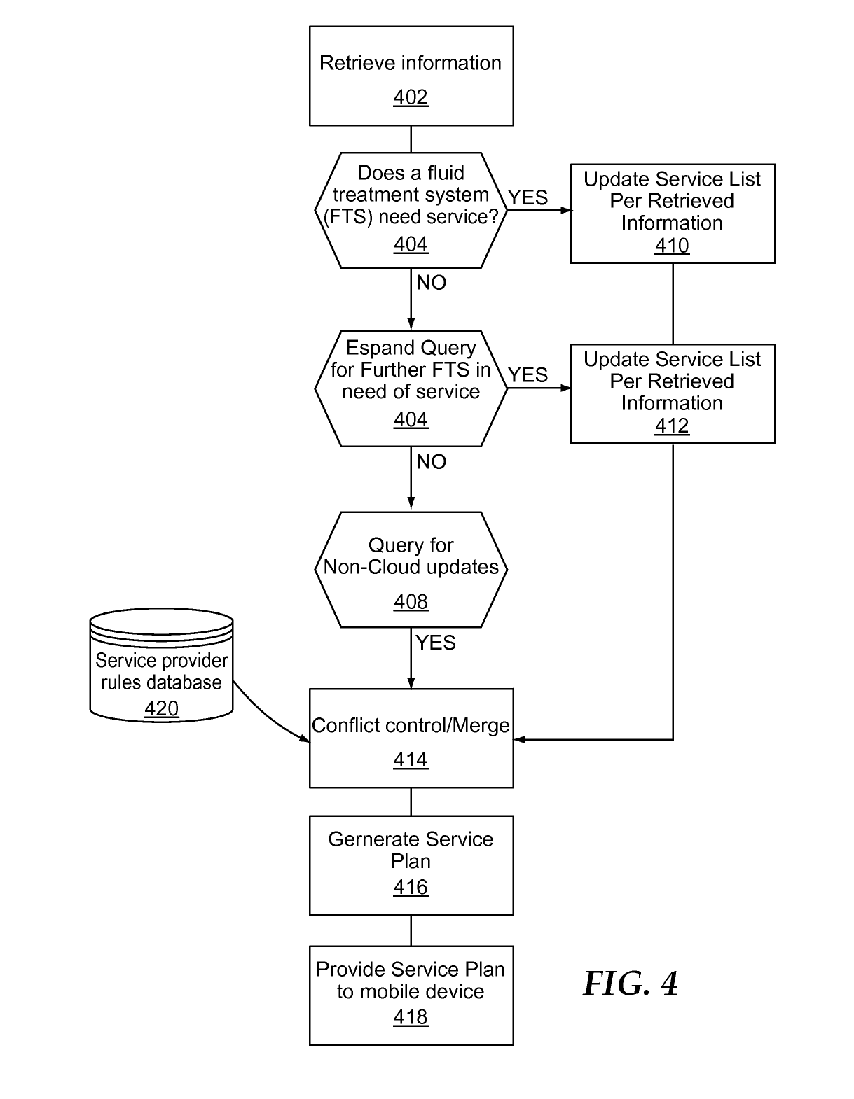

FIG. 4 shows a method of creating a service plan, consistent with embodiments of the present disclosure. In step 402, a service provider computer retrieves information from a central database or cloud regarding fluid treatment systems that the service provider services. The computer determines, based on the information retrieved, whether a fluid treatment system is in need of service. If, after an initial processing of the information, the query fails to yield a fluid treatment system in need of service, it is then expanded in step 406. The expanded query can be based on time frame, for example. If the expanded query still fails to yield one or more fluid treatment systems in need of service, then the computer queries for non cloud updates in step 408. Non-cloud updates can include information provided directly by fluid monitoring apparatus at customer sites. It can also include whether the manufacturer of the fluid treatments system or fluid monitoring apparatus has service updates. If at step 404 it is determined that one or more fluid treatment systems are in need of service, a master service list including systems in need of service is updated at step 410. If the expanded query results in fluid treatment systems in need of service, than the service list is updated in step 412. In step 414 the list of fluid treatment systems in need of service based on non cloud updates is checked for conflicts and merged with the list of fluid treatment systems in need of service from step 412. Any conflicts between the two can be resolved based on a set of service provider rules stored in database 420. The merged list of fluid treatment systems in need of service is then used to generate one or more service plans in step 416. The service plan may group systems based on one type of service to be provided, or location, for example. The one or more service plans generated in step 416 are provided to one or more mobile devices in step 418.

Portions of the above detailed description may be presented in the contexts of processes (algorithms) and symbolic representations of operations on data bits. These algorithmic descriptions and representations are used in the data processing arts to convey the substance of the described work to others. An algorithm, as described herein, refers to a self-consistent sequence of acts leading to a desired result, and involving physical manipulations of physical aspects and/or quantities. These quantities may take the form of radio frequency (RF) signal, magnetic signals, or other types of signals, capable of being stored, transferred, combined, compared, and otherwise manipulated. Moreover, principally for reasons of common usage, these signals are referred to as bits, values, elements, symbols, characters, terms, numbers, and/or the like.

Unless specifically stated otherwise, it is appreciated that discussions utilizing terms such as “processing” or “computing” or “determining” or “displaying” or the like, refer to the action and processes of a logic circuit (such as a computer system, combinational and/or sequential electronic logic circuitry, a configurable or programmable circuit or a similar electronic computing device) that manipulates and transforms data represented as physical (electronic) quantities within the computer system's devices into other data similarly represented as physical quantities within the computer system devices such as memories, registers or other such information storage, transmission, display devices, or the like. As indicated in the examples provided above, such data is transformed for the purpose of changing the related representations of the physical aspects or quantities.

The algorithms and displays presented herein are not inherently related to any particular computer or other apparatus. Unless otherwise indicated, various general purpose systems and/or logic circuitry may be used with programs in accordance with the teachings herein, or it may prove convenient to construct more specialized apparatus to perform the required method. For example, any of the methods according to the present disclosure can be implemented in hard-wired circuitry, by programming a general purpose processor, other fully or semi-programmable logic circuitry, and/or by any combination of such hardware and software.

One would appreciate that the disclosure can be practiced with computer system configurations other than those described herein, including hand-held devices, multiprocessor systems, microprocessor-based or programmable consumer electronics, digital signal processing (DSP) devices, network PCs, minicomputers, mainframe computers, and the like. The disclosure can also be practiced in distributed computing environments where tasks are performed by remote processing devices that are linked through a communications network. The required structure for a variety of these systems and circuits would be apparent from the intended application and the above description.

It is to be understood that various terms and techniques are used to describe communications, protocols, applications, implementations, mechanisms, etc. One such technique is expressed in terms of an algorithm or mathematical expression. While the technique may be, for example, implemented as executing code on a computer, the expression of that technique may be more aptly and succinctly conveyed and communicated as a formula, algorithm, or mathematical expression. As an example, one would recognize a block denoting “C=A+B” as an additive function whose implementation in hardware and/or software would take two inputs (A and B) and produce a summation output (C), such as in combinatorial logic circuitry. Thus, the use of formula, algorithm, or mathematical expression as descriptions is to be understood as having a physical embodiment in at least hardware and/or software (such as a computer system in which the techniques of the present disclosure may be practiced as well as implemented as an embodiment).

In an embodiment, methods consistent with the present disclosure are embodied in machine-executable instructions. The instructions can be used to cause a general-purpose or special-purpose processor that is programmed with the instructions to perform the steps of the present disclosure. Alternatively, the steps of the present disclosure might be performed by specific hardware components that contain hardwired logic for performing the steps, or by any combination of programmed computer components and custom hardware components. In certain embodiments, aspects of the present disclosure are provided as computer program products which may include a machine or computer-readable medium having stored thereon instructions which may be used to program a computer (or other electronic devices) to perform a process according to the present disclosure. Moreover, the present disclosure may also be downloaded as a computer program product. For example, in one embodiment, the instructions cause such a computer to perform a method with the following steps. First, the computer retrieves information from a remote database. The information from the database stores usage, status, and location information from at least one of a plurality of fluid monitoring apparatuses for respective fluid treatment systems, based partly on each fluid monitoring apparatus located at a respective customer site and configured for transmitting at least usage and status information to the database. Second, using the information received, the computer determines whether said at least one of the plurality of fluid treatment systems is in need of service. Next, the computer determines whether one or more additional ones of the plurality of fluid treatment systems, located in a predefined area surrounding the at least one of the plurality of fluid treatment systems, have status or usage information indicating service can be performed within a predetermined time range. A service plan is then generated for display, and the service plan is used by a service agent with the service plan including a service route, location of fluid treatment systems to be serviced, type of service to be performed on each fluid treatment system, and estimated duration of each service. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

Based upon the above discussion and illustrations, it is readily recognizable that various modifications and changes may be made to the present disclosure without strictly following the exemplary embodiments and applications illustrated and described herein. For example, a variety of different types of registers, communication protocols and data can be communicated using one or more approaches as discussed herein. Such modifications do not depart from the true spirit and scope of the present disclosure, including that set forth in the following claims.

What is claimed is:

1. A method comprising:
retrieving information from a remote computer node including a database circuit, the database of the remote computer node storing usage, status, and location information from a plurality of fluid monitoring apparatus for respective fluid treatment systems, each fluid monitoring apparatus located at a respective customer site and transmitting usage or status information to the remote database;
determining, from the information received, whether at least one of the plurality of fluid treatment systems is in need of service, the need for service determined based on one or more of the usage or status information;
determining automatically whether one or more additional ones of the plurality of fluid treatment systems, located in a predefined area surrounding the at least one of the plurality of fluid treatment systems, is in need of service;
generating, for display, a service plan for a service agent, the service plan including a service route and location of one or more fluid treatment systems to be serviced, and indicating type of service to be performed on each fluid treatment system or an estimated duration of each service.

2. The method of claim 1, further including automatically generating and sending email notifications to customer sites, the email including information regarding the service intended to be completed, an approximate time of arrival, and the estimated duration of the service.

3. The method of claim 1, further including automatically ordering parts based on the services to be performed.

4. The method of claim 1, wherein the service route is generated as a function of the type of service to be performed or the estimated duration of each service, and further including providing the service plan to a mobile device.

5. The method of claim 1, wherein the service route is optimized for minimum travel time.

6. The method of claim 1, wherein the service plan is updated based on at least one of: new information retrieved from the remote database, location of service agent, and services previously preformed.

7. The method of claim 1, wherein the service plan includes GPS information.

8. The method of claim 1, wherein retrieving information from the remote database includes retrieving information for each fluid treatment system having a service agreement with a particular service provider.

9. The method of claim 1, further including forwarding the service plan to a mobile device and providing turn by turn GPS driving directions to the service agent.

10. The method of claim 1, wherein the determination of a need for service is based on a threshold, the threshold involving at least one of: status information and usage level.

11. The method of claim 10, wherein the threshold for determining whether at least one of the plurality of fluid treatment systems is in need of service is different than a threshold for determining whether one or more additional ones of the plurality of fluid treatment systems is in need of service.

12. A method of operating a computer-based node including a CPU circuit and an electronic database, the method comprising:
receiving information from a plurality of fluid monitoring apparatuses, each fluid monitoring apparatus located at a respective customer site and monitoring the activity of a fluid treatment system;
determining, based on the information received from the plurality of fluid monitoring apparatus, whether one or more of the plurality of fluid treatment systems is in need of service;
determining automatically via the CPU circuit, in response to one or more plurality of fluid treatment systems being in need of service, which of a plurality of service providers provides service to each of the respective fluid treatment systems in need of service;
notifying one or more of the plurality of service providers of the fluid treatment systems in need of service in the service provider's service area;
receiving, from the service provider, the location of a service agent and, in response, generating, a service plan including a route, location of the customer site to be serviced, type of service to be performed on each fluid treatment system, and estimated duration of each service; and
sending the service plan to the service agent for display.

13. The method of claim 12, wherein the service plan is sent to a mobile device, and the service provider's service area is ascertained from information stored at the computer node.

14. The method of claim 12, wherein the location of the service agent is in the form of GPS information.

15. The method of claim 12, wherein an updated service plan is sent to the service agent in response to a change in status for at least one fluid treatment system.

16. The method of claim 12, further including notifying each customer site of an estimated time of arrival of the service agent, the type of service to be performed on the fluid treatment system, and the estimated duration of service.

17. A method comprising:
monitoring various aspects of a fluid treatment system using a sensor;
determining, based on data collected by the sensor, a status of one or more aspects of the fluid treatment system;
providing, to an offsite computer node including a database, information regarding location of the fluid treatment system, the status of the one or more aspects of the fluid treatment system, and what services are needed;
providing, in response to a change in status, updated information to the database at the offsite computer node.

18. The method of claim 16, wherein the updated information includes information regarding the time of the status change.

19. The method of claim 16, wherein the information regarding location of the fluid treatment system includes a venue ID.

20. The method of claim 19, wherein the venue ID is used to retrieve location information from a lookup table.

21. The method of claim 16, wherein the sensor is at least one of a transducer, a flow rate sensor, conductivity sensor, or a reverse osmosis filter.

22. The method of claim 16, wherein the information regarding location of the fluid treatment system includes GPS information.

23. The method of claim 16, wherein the change in status indicates the fluid treatment system is in need of service.

24. The method of claim 16, wherein the change in status indicates the fluid treatment system is not in need of service.

25. A computer-readable medium having instructions executable by a computer, the instructions causing the computer to perform the method including:
retrieving information from a remote database, the information from the database storing usage, status, and location information from at least one of a plurality of fluid monitoring apparatuses for respective fluid treatment systems, each fluid monitoring apparatus located at a respective customer site and configured for transmitting at least usage and status information to the database;
determining, from the information received, whether said at least one of the plurality of fluid treatment systems is in need of service;
determining whether one or more additional ones of the plurality of fluid treatment systems automatically, located in a predefined area surrounding the at least one of the plurality of fluid treatment systems, have status or usage information indicating service can be performed within a predetermined time range;
generating, for display, a service plan for a service agent, the service plan including a service route, location of fluid treatment systems to be serviced, type of service to be performed on each fluid treatment system, and estimated duration of each service.

26. The method of claim 25, further including automatically generating and sending email notifications to customers associated with fluid treatment systems to be serviced, the email including at least one of: information regarding the service intended to be completed, an approximate time of arrival and the estimated duration of service.

27. The method of claim 25, further including automatically ordering parts based on the services to be performed.

28. The method of claim 25, wherein the computer is a mobile device.

29. The method of claim 25, wherein the service route is optimized for minimum travel time.

30. The method of claim 25, wherein the service plan is updated based the location of the service agent.

31. A method for execution by a computer-based circuit including a computer, the method including:
retrieving information from a remote computer node including a database, the information from the database at the remote computer node storing usage, status, and location information from a plurality of fluid monitoring apparatus for respective fluid treatment systems, each fluid monitoring apparatus located at a respective customer site and transmitting at least usage and status information to the remote database;
determining, from the information received, whether at least one of the plurality of fluid treatment systems is in need of service;
determining whether one or more additional ones of the plurality of fluid treatment systems, located in a predefined area surrounding the at least one of the plurality of fluid treatment systems, have status or usage information indicating service can be performed within a predetermined time range;
generating and displaying a service plan for a service agent, the service plan including a service route, location of fluid treatment systems to be serviced, type of service to be performed on each fluid treatment system, and estimated duration of each service.

32. The method of claim 31, further including automatically generating and sending email notifications to customers associated with fluid treatment systems to be serviced, the email including at least one of: information regarding the service intended to be completed, an approximate time of arrival and the estimated duration of service.

33. The method of claim 31, further including automatically ordering parts based on the services to be performed.

34. The method of claim 31, wherein the computer is a mobile device.

35. The method of claim 31, wherein the service route is optimized for minimum travel time.

36. The method of claim 31, wherein the service plan is updated based the location of the service agent.

37. A method comprising:
a computer node including a database circuit receiving and storing information, in the database circuit, from a plurality of fluid monitoring apparatuses located at different customer sites;
based on information received from the plurality of fluid monitoring apparatuses and the information associated with the service provider, assessing whether one or more of the plurality of fluid treatment systems in a service area is in need of service, and generating a list of fluid treatment systems in need of service;
maintaining a list of authorized service providers and permitting communications therewith, for providing access to at least a portion of the data indicating fluid treatment systems in need of service;
generating, from the list of fluid treatments systems in need of service and based on the maintained list, a service plan including a service route and location of one or more fluid treatment systems to be serviced and indicating type of service to be performed on each fluid treatment system or the estimated duration of each service; and
providing the service plan to the service provider for display.

38. The method of claim 37, wherein identifying information received from the service provider is a username and password.

39. The method of the claim 37, further including storing information for a plurality of service providers, each service provider having a contract granting access to a portion of the information received from the respective customer sites.

40. The method of claim 39, wherein the stored information associated with the service provider includes details regarding the contract and wherein the contract includes at least one of:
types of services provided by the service provider, customer sites serviced by the service provider, and service area of the service provider.

41. The method of claim 37, further including receiving information from a customer site regarding service provider preferences, the preferences including at least one of: service provider, time of service, and manner of notification of service to be performed.

42. The method of 37, further including notifying the one or more customer sites included in the service plan regarding an estimated time of arrival of a service agent.

43. The method of claim 37, wherein the service plan is sent to a mobile device.

44. The method of claim 43, wherein the service plan is updated based on GPS information received from the mobile device.

45. The method of claim 37, further including receiving a subset of fluid treatments systems selected by the service provider from the list of fluid treatment systems, and wherein the service plan is generated based on the subset of fluid treatment systems.

46. The method of claim 37, further including restricting access to information stored on the computer node based on the stored information associated with the service provider.
